(19) United States
(12) Patent Application Publication
(10) Pub. No.: US 2026/0202981 A1
(43) Pub. Date: Jul. 16, 2026

(54) EXPANSION OF EQUIPMENT AND VOLUME PLACEMENT BASED ON THE DURATION OF THE CONTRACT

(71) Applicant: Hitachi Vantara, Ltd., Yokohama-shi (JP)

(72) Inventors: Takanobu SUZUKI, San Jose, CA (US); Hiroyuki OSAKI, Los Gatos, CA (US)

(21) Appl. No.: 19/025,720

(22) Filed: Jan. 16, 2025

(51) Int. Cl. G06F 3/06

(52) U.S. Cl. CPC G06F 3/0644; G06F 3/0607; G06F 3/0665; G06F 3/067

(57) ABSTRACT

Systems and methods for a storage management system configured to manage storage systems, involving, for a start of a lead time defined for an expansion cycle being reached, generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; for the suggestion being accepted, adding the capacity amount to the storage systems.

### BACKGROUND

### Field

The present disclosure is generally related to storage systems, and more specifically, towards equipment and volume management based on contact duration.

### Related Art

Service provider administrators (e.g., storage management team) design infrastructure resources to accommodate future demands for performance and capacity of various applications. Such administrators have a need to reduce the amount of resources used and to automate the resource design. Since there is a growing shortage of skilled engineers, there is a need to automate the resource design in order to manage infrastructure design within a limited number of skilled engineers.

In the related art, there is a method to determine if the storage device can operate for a predetermined period of time based on the rate of increase in the capacity used by the storage device. However, such methods do not take into account the characteristics regarding the change in demand for each application nor the storage device characteristics. When trying to keep up with rapid changes in application demand, equipment expansion can become necessary within a short span of time, resulting in an explosive increase in man-hours. As more capacity is purchased to absorb application demand fluctuations, excess capacity can be available in the event of cancellations.

Generally, the change of demand is hard to predict. However, a correlation between changes in demand for applications and the duration of service contracts is expected to be observable. For example, if demand fluctuation is expected to be large, users of the service will shorten the contract period. Conversely, if demand fluctuations are expected to be small, the contract period will be longer.

### SUMMARY

There is a need in the related art to be able to add equipment capacity while reducing the frequency of work and taking into account the contract period for each application. There is a further need to adding capacity based on the characteristics of on-prem storage devices (long procurement lead times) and storage in the cloud (short procurement lead times).

The example implementations described herein are directed to calculating and proposing a forecasted value for the amount of expansion based on the used capacity, remaining contract period, and contract renewal rate, while meeting the infrastructure engineer's desired expansion cycle, placing volumes with large fluctuations on storage systems in the cloud with short lead times, and placing volumes with small fluctuations on on-prem storage systems with long lead times. If the contract renewal rate is above a certain level at the time of expansion or at the time the contract expires, example implementations can also propose that the contract be made longer.

Aspects of the present disclosure can involve a method for a storage management system configured to manage storage systems, the method including, for a start of a lead time defined for an expansion cycle being reached, generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and for the suggestion being accepted, adding the capacity amount to the storage systems.

Aspects of the present disclosure can involve a computer program storing instructions for a storage management system configured to manage storage systems, the instructions including, for a start of a lead time defined for an expansion cycle being reached, generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and for the suggestion being accepted, adding the capacity amount to the storage systems. The computer program and instructions can be stored on a non-transitory computer readable medium and executed by one or more processors.

Aspects of the present disclosure can involve a storage management system configured to manage storage systems, the system including, for a start of a lead time defined for an expansion cycle being reached, means for generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and for the suggestion being accepted, means for adding the capacity amount to the storage systems.

Aspects of the present disclosure can involve a storage management system configured to manage storage systems, the system including, a processor, configured to, for a start of a lead time defined for an expansion cycle being reached, generate a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and for the suggestion being accepted, add the capacity amount to the storage systems.

Aspect of the present disclosure can include a method for a storage management system configured to manage storage systems, the method including, for receipt of a request to generate a new volume, determining a location in the storage systems to place the new volume based on an expansion cycle for each device, expansion lead time, capacity availability, contract term for each application, and contract renewal rate; and generating the new volume in the determined location.

Aspect of the present disclosure can include a computer program, storing instructions for a storage management system configured to manage storage systems, the instructions including, for receipt of a request to generate a new volume, determining a location in the storage systems to place the new volume based on an expansion cycle for each device, expansion lead time, capacity availability, contract term for each application, and contract renewal rate; and generating the new volume in the determined location. The computer program and instructions can be stored on a non-transitory computer readable medium and executed by one or more processors.

Aspect of the present disclosure can include a storage management system configured to manage storage systems, the system including, for receipt of a request to generate a new volume, means for determining a location in the storage systems to place the new volume based on an expansion cycle for each device, expansion lead time, capacity availability, contract term for each application, and contract renewal rate; and means for generating the new volume in the determined location.

Aspect of the present disclosure can include a storage management system configured to manage storage systems, the system including, a processor, configured to, for receipt of a request to generate a new volume, determine a location in the storage systems to place the new volume based on an expansion cycle for each device, expansion lead time, capacity availability, contract term for each application, and contract renewal rate; and generate the new volume in the determined location.

### BRIEF DESCRIPTION OF DRAWINGS

FIG. 1 illustrates an example overall system structure upon which example implementations can be implemented.

FIG. 2 illustrates the elements of storage monitoring and prediction modules and elements of storage management tables, in accordance with an example implementation.

FIG. 3 illustrates an example use case diagram for Storage Management Service, in accordance with an example implementation.

FIG. 4 illustrates an example screen shot that Storage Management Service displays to provider for the service catalogue setting, in accordance with an example implementation.

FIG. 5 illustrates an example screenshot that Storage Management Service displays to the provider for the storage device configuration, in accordance with an example implementation.

FIG. 6 illustrates an example a screenshot that Storage Management Service displays to the provider for the resource information registration, in accordance with an example implementation.

FIG. 7 illustrates an example screenshot that Storage Management Service displays to the Consumer to ask them to enter the settings for the volume to be purchased for Volume Creation, in accordance with an example implementation.

FIG. 8 illustrates examples of tables for managing information on storage devices, in accordance with an example implementation.

FIG. 9 illustrates examples tables for managing information on server for managing servers and volume contracts, in accordance with an example implementation.

FIG. 10 illustrates example tables for managing information on server for managing volumes, in accordance with an example implementation.

FIG. 11 illustrates an example processing flow in storage management service when the expansion process starts or the system capacity is used up, in accordance with an example implementation.

FIG. 12 illustrates an example of the processing flow in storage management service when a volume creation request is issued, in accordance with an example implementation.

FIG. 13 illustrates an example of the processing flow in storage management service when a volume creation request is issued, in accordance with an example implementation.

FIG. 14 illustrates an example of the processing flow in storage management service when a volume creation request is issued, in accordance with an example implementation.

FIG. 15 illustrates the processing flow in storage management service when some capacity usage of the storage devices in on-premise data centers exceeds threshold, in accordance with an example implementation.

FIG. 16 illustrates the processing flow in storage management service when some capacity usage of the storage devices in on-premise data centers is lower than threshold, in accordance with an example implementation.

FIG. 17 illustrates the processing flow in storage management service when consumers renew their contract of volume service, in accordance with an example implementation.

FIG. 18 illustrates an example computing environment with an example computer device suitable for use in some example implementations according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

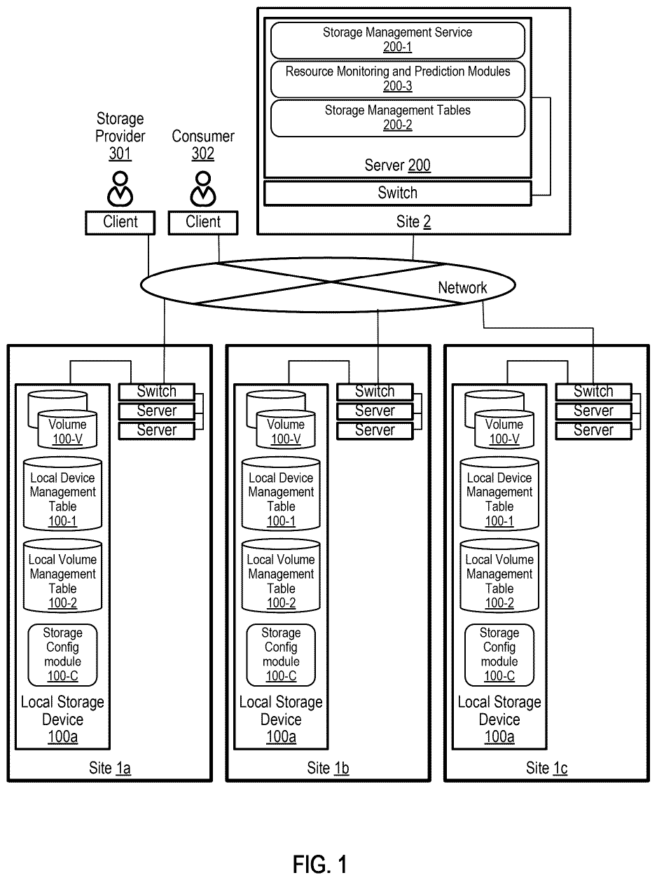

FIG. 1 illustrates an example overall system structure upon which example implementations can be implemented. The system includes multiple sites 1a, 1b, 1c and Site 2. These connects to each other via network (e.g. internet). Consumer 302 operates the storage services over network, Provider 301 manages the system for providing storage services. The storage service application, which provides storage services at sites 1a, 1b, and 1c, runs on Site 2. The storage service application involves the storage management service 200-1, Resource monitoring and prediction modules 200-3, and storage management tables 200-2.

Sites 1a, 1b and 1c are connected by a network (e.g. Wide Area Network) and can manage one or more volumes 100-V. Each site has computer servers and switches, and Local Storage Device 100a. These are connected by LAN (Local Area Network) and/or SAN (Storage Area Network). Some virtual machines, containers, and applications run on servers and their data is stored on Local Storage Device 100a. Storage device 100a has a storage config module 100-C for device and volume configuration. Local device management table 100-1 stores device information such as the identifier (ID), address, capacity, and so on. Local volume management table 100-2 stores a list of volume information such as ID, capacity, and so on.

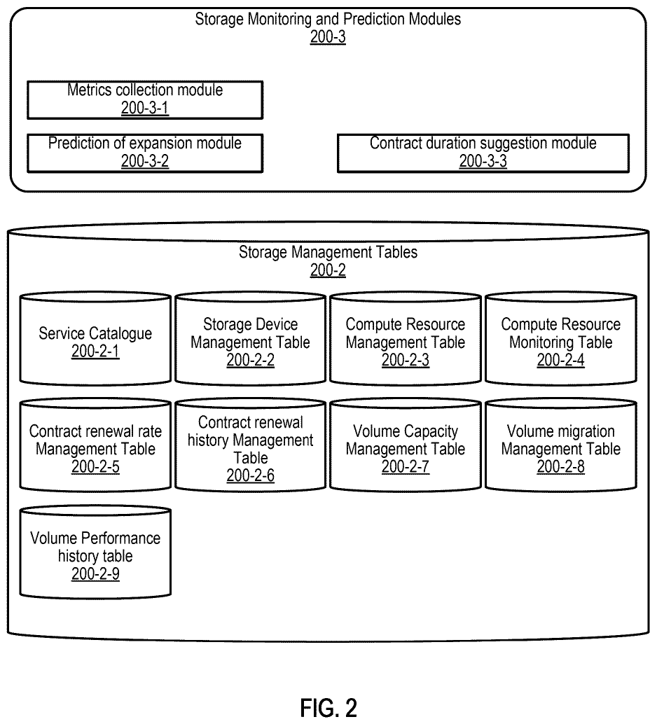

FIG. 2 illustrates the elements of storage monitoring and prediction modules 200-3 and elements of storage management tables 200-2, in accordance with an example implementation. Storage monitoring and prediction modules 200-3 can include the following modules.

Metrics collection module 200-3-1 collects storage metrics (used capacity, performance, and so on) and server metrics (CPU usage, memory usage, and so on). Metrics collection module 200-3-1 collects metrics via network. Prediction of expansion module 200-3-2 predicts the amount of additional parts (Solid State Drives, and so on) based on the prediction of contract duration and volume usage of users. Contract duration suggestion module 200-3-3 suggests the duration of the volume service contract based on their contract history and volume usage.

Storage management tables 200-2 can include the following information. Service catalogue 200-2-1 is a table that stores a list of volume services and their settings provided by Provider 301 to Consumer 302. Storage device management table 200-2-2 is a table that stores a list of storage devices of all sites managed by Provider 301. Compute resource management table 200-2-3 is a table that stores a list of servers of all sites managed by Provider 301. Compute resource monitoring table 200-2-4 is a table that stores a list of server metrics and its environment grouped by site. Contract renewal rate management table 200-2-5 is a table that stores a list of contract renewal rate of each user and each volume. In this example implementation, 95 percentile probability of contract renewal is used as the rate. Contract renewal history management table 200-2-6 is a table that stores a list of contract renewal history of each user and each period. In this example implementation, one month is used as the period because the shortest contract duration is one month.

Volume capacity management table 200-2-7 is a table that stores a list of past and current used capacity and predicted used capacity of each volume. Volume migration management table 200-2-8 is a table that stores a list of volume migration status of each volume. Volume performance history table 200-2-9 is a table that stores a list of volume performance statistics of each volume.

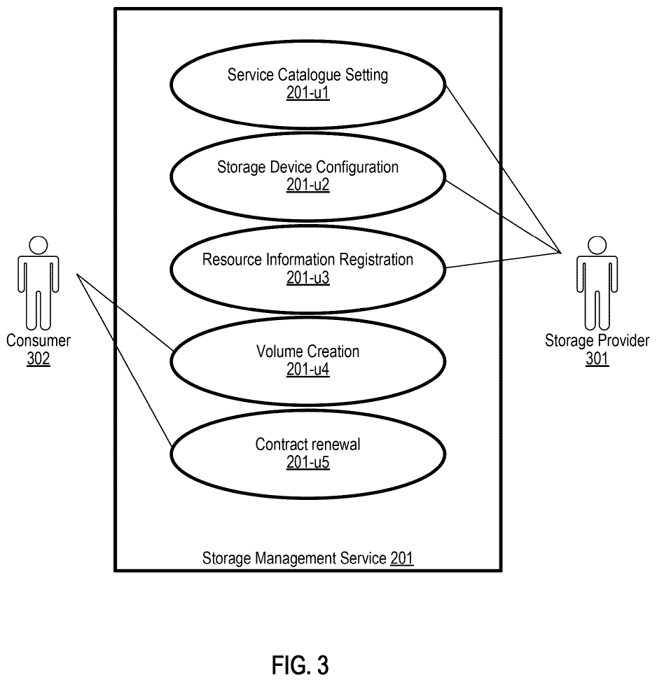

FIG. 3 illustrates an example use case diagram for Storage Management Service 200-1, in accordance with an example implementation. Storage provider 301 performs can manage the following functions.

Service catalogue setting 201-u1: Provider 301 performs service catalogue settings. It may be reconfigured as system requirements change.

Resource information registration 201-u2: Provider 301 registers available servers and its resource (CPU, memory, and so on), and available storage devices and its resources(capacity, and so on). This operation can be done by automatic generation from the system configuration and/or information from servers and storage devices, rather than manual input by provider 301. Provider 301 will change parameters when there is a change in system.

Storage device configuration 201-u3: Provider 301 performs storage device installation, expand/shrink/remove storage devices on on-premise, create/expand/shrink/remove storage systems on cloud, configuration and update the table.

Storage consumer 302 manages the following functions.

Volume creation 201-u4: Consumer 302 creates volumes by inputting volume type, capacity, performance, and so on.

Contract renewal 201-u5: Consumer 302 renews or cancel volume service contract.

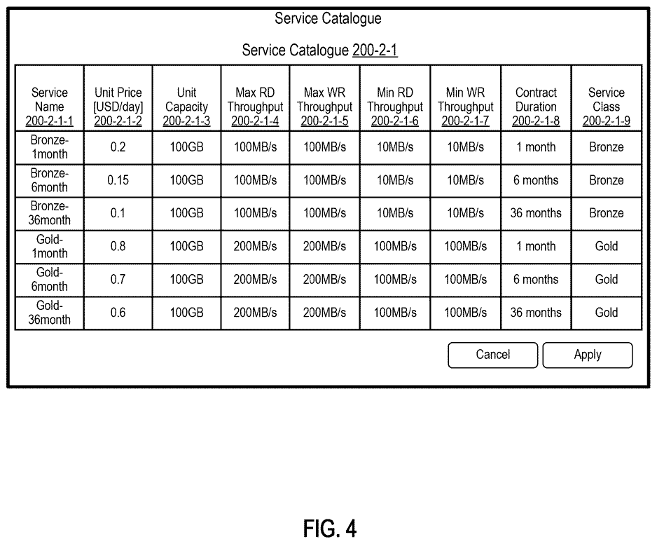

FIG. 4 illustrates an example screenshot that Storage Management Service 200-1 displays to Provider 301 for the service catalogue setting 201-u1, in accordance with an example implementation. This screen displays the information stored in 200-2-1 and accepts edits. Service Catalogue 200-2-1 manages the list of storage volume provisioning services tied to the Service class 200-2-1-1, and includes unit price 200-2-1-2, unit capacity 200-2-1-3, max read throughput 200-2-1-4, max write throughput 200-2-1-5, min read throughput 200-2-1-6, min write throughput 200-2-1-7 and contract duration 200-2-1-8 as well as service class 200-2-1-9.

Service Name 200-2-1-1 is a unique name in the system. Unit price 200-2-1-2 indicates the cost that will be incurred when one unit of the service is purchased. Unit capacity 200-2-1-3 indicates the capacity that will be provided when one unit of the service is purchased. Max read throughput 200-2-1-4 indicates the maximum read throughput that will be provided when one unit of the service is purchased. Max write throughput 200-2-1-5 indicates the maximum write throughput provided when one unit of the service is purchased. Min read throughput 200-3-6 indicates the minimum read throughput that will be provided if servers create read requests exceeding the throughput for when one unit of the service is purchased. Min write throughput 200-3-7 indicates the minimum write throughput that will be provided if servers create write requests exceeding the throughput provided when one unit of the service is purchased. Contract duration 200-2-1-8 indicates the duration of the service. This duration does not depend on the number of purchased units. For example, should consumer 302 purchases five units of Bronze—1 month service, the duration of the contract is thereby one month.

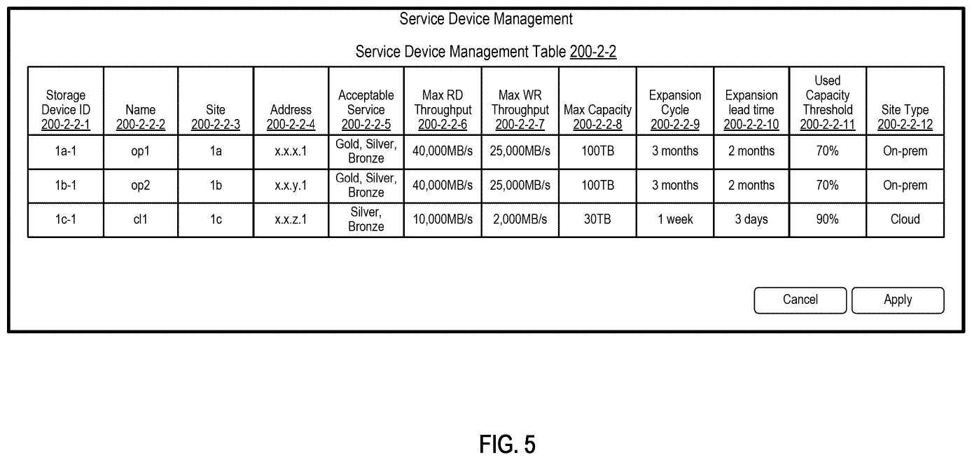

FIG. 5 illustrates an example screenshot that Storage Management Service 200-1 displays to the provider 301 for the storage device configuration 201-u2, in accordance with an example implementation.

This screen displays the information stored in 200-2-2 and accepts edits. Storage device management table 200-2-2 manages the list of storage devices tied to storage device ID 200-2-2-1, and includes name 200-2-2-2, site 200-2-2-3, address 200-2-2-4, acceptable service 200-2-2-5, max read throughput 200-2-2-6, max write throughput 200-2-2-7, max capacity 200-2-2-8, expansion cycle 200-2-2-9, expansion lead time 200-2-2-10, used capacity threshold 200-2-2-11, and site type 200-2-2-12.

Storage device ID 200-2-2-1 is a unique ID in the system. Name 200-2-2-2 is a unique name in the system. Site 200-2-2-3 is the site name where the storage device is located. Address 200-2-2-4 is a unique address, such as Internet Protocol (IP) address or Domain Name Service (DNS) name, in the system. Acceptable service 200-2-2-5 is a set of service class that is acceptable at the storage device. Service classes are defined in 200-2-1. Max read throughput 200-2-2-6 indicates the maximum read throughput that will be provided by the storage device. Max write throughput 200-2-2-7 indicates the maximum write throughput that will be provided by the storage device. Max capacity 200-2-2-8 indicates the maximum usable capacity that will be provided the storage device. Expansion cycle 200-2-2-9 indicates the duration between hardware expansion works. Expansion lead time 200-2-2-10 indicates the duration between ordering hardware expansion to finishing hardware expansion. Used capacity threshold 200-2-2-11 indicates the percentage of total capacity. If used capacity exceeds this threshold, then storage management software can alert to provider 301. Site type 200-2-2-12 indicates the site type, which is on-prem or cloud.

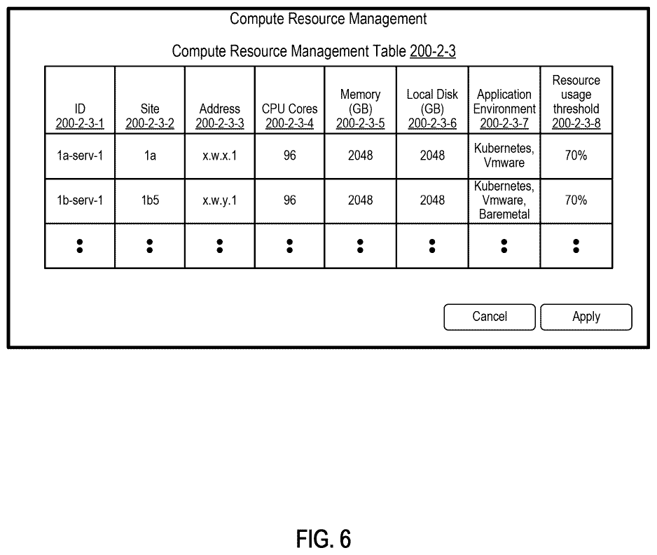

FIG. 6 illustrates an example a screenshot that Storage Management Service 200-1 displays to provider 301 for resource information registration 201-u3, in accordance with an example implementation.

This screen displays the information stored in 200-2-3 and accepts edits.

Storage device management table 200-2-2 manages the list of storage devices tied to storage device ID 200-2-3-1, and includes site 200-2-3-2, address 200-2-3-3, CPU cores 200-2-3-4, memory 200-2-3-5, local disk 200-2-3-6, application environment 200-2-3-7, resource usage threshold 200-2-2-8. ID 200-2-3-1 is a unique ID in the system. Site 200-2-3-2 is the site name where the storage device is located. Address 200-2-3-3 is a unique address, such as IP address or DNS name, in the system. CPU cores 200-2-3-4 indicates a number of CPU cores that is usable of the server whose ID is ID 200-2-3-1. Memory 200-2-3-5 indicates the amount of memory that is usable of the server whose ID is ID 200-2-3-1. Local disk 200-2-3-6 indicates the maximum capacity of local disk that is usable of the server whose ID is ID 200-2-3-1. Application environment 200-2-3-7 indicates a set of usable computer service that can be used on the server. Resource usage threshold 200-2-3-8 indicates the percentage of CPU usage and memory usage. If the used resources exceed this threshold, then storage management software can send an alert to provider 301.

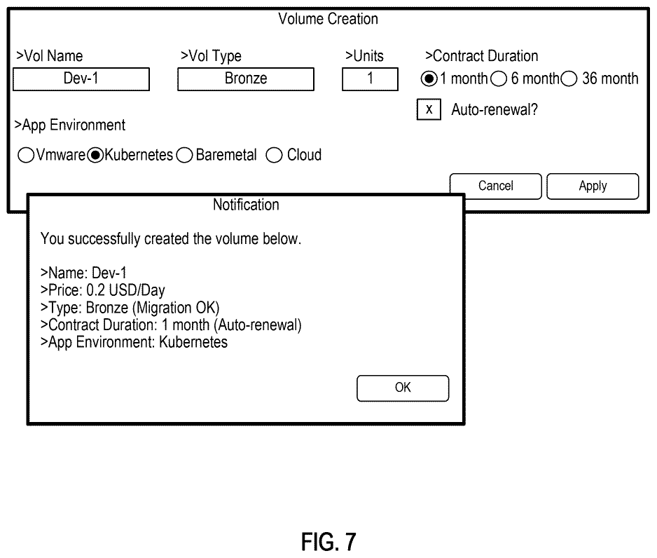

FIG. 7 illustrates an example screenshot that Storage Management Service 200-1 displays to the Consumer 302 to ask them to enter the settings for the volume to be purchased for Volume Creation 201-u4, in accordance with an example implementation. Consumer 302 names the individual volume, selects a use and a type and from the information provided in the volume catalog, checks migratable if the volume can be migrated, enters the number of units to be set for the storage devices 100a, selects contract duration regarding whether it is auto-renewal or not, and select the application environment that the volume is used for. If the volume is successfully created, the name, total price, the type, and contract duration and auto-renewal or not, and app environment are displayed.

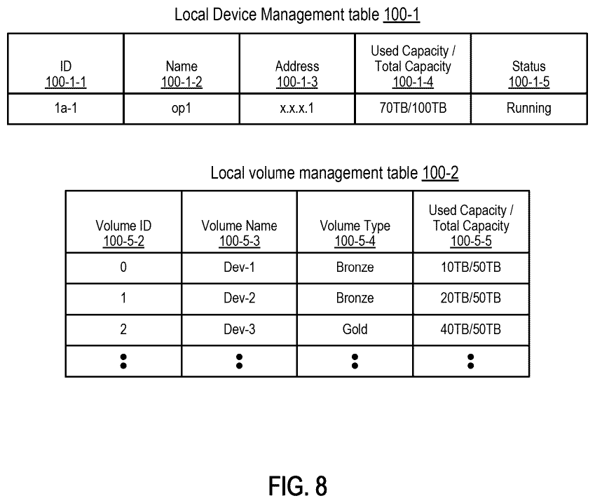

FIG. 8 illustrates examples of tables for managing information on storage devices 100a, in accordance with an example implementation. Local device management table 100-1 stores information of the storage device. The information can include ID 100-1-1, name 100-1-2, address 100-1-3, used capacity and total capacity 100-1-4, and status 100-1-5. Local volume management table 100-2 stores information of the volumes in the storage clusters, which can include Volume ID 100-2-1, volume name 100-2-3, volume type 100-2-4, used capacity and total capacity of its cluster 100-2-5.

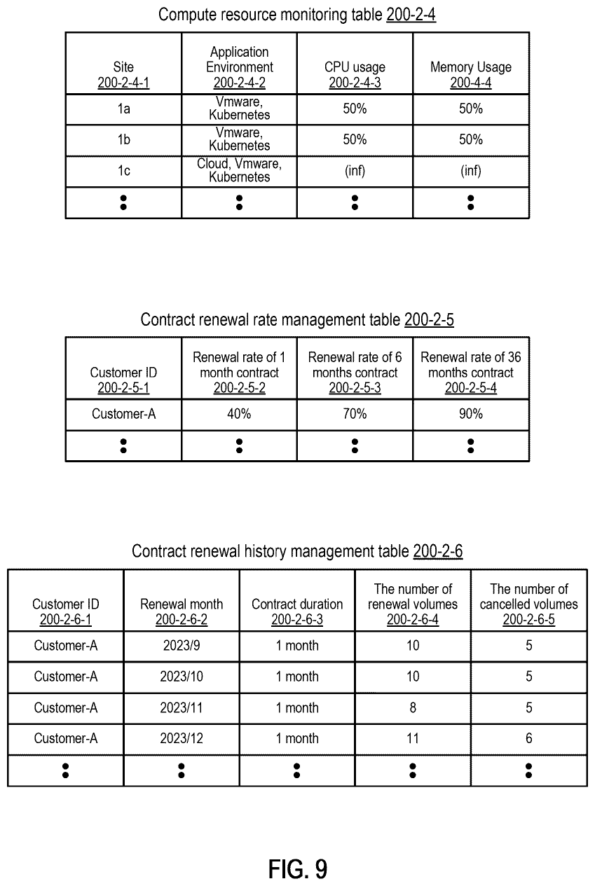

FIG. 9 illustrates examples tables for managing information on server 200 for managing servers and volume contracts, in accordance with an example implementation. Computer resource monitoring table 200-2-4 stores information of servers group by site and can include Site 200-2-4-1, application environment 200-2-4-2, CPU usage 200-2-4-3, and memory usage 200-2-4-4. Site 200-2-4-1 is unique in the system. Application environment 200-2-4-2 is the set of usable application environments in the site. CPU usage 200-2-4-3 and memory usage 200-2-4-4 are the total usage of servers in the site.

Contract renewal rate management table 200-2-5 stores information of the renewal rate of each customer and can include Customer ID 200-2-5-1, renewal rate of one month contract 200-2-5-2, renewal rate of six months contract 200-2-5-3, and renewal rate of 36 months contract 200-2-5-4. Customer ID 200-2-5-1 is unique within the system. Renewal rate of X month contract 200-2-5-2, 200-2-5-3, 200-2-5-4 store the probability of the contract renewal of volume group by customer. In this example, 95 percentile of renewal rate of volumes is used as the probability.

Contract renewal history management table 200-2-6 stores information of the renewal rate of each volume, and can include Customer ID 200-2-6-1, renewal month 200-2-6-2, contract duration 200-2-6-3, the number of renewal volumes 200-2-6-4, and the number of cancelled volumes 200-2-6-5. Customer ID 200-2-6-1 is unique within the system.

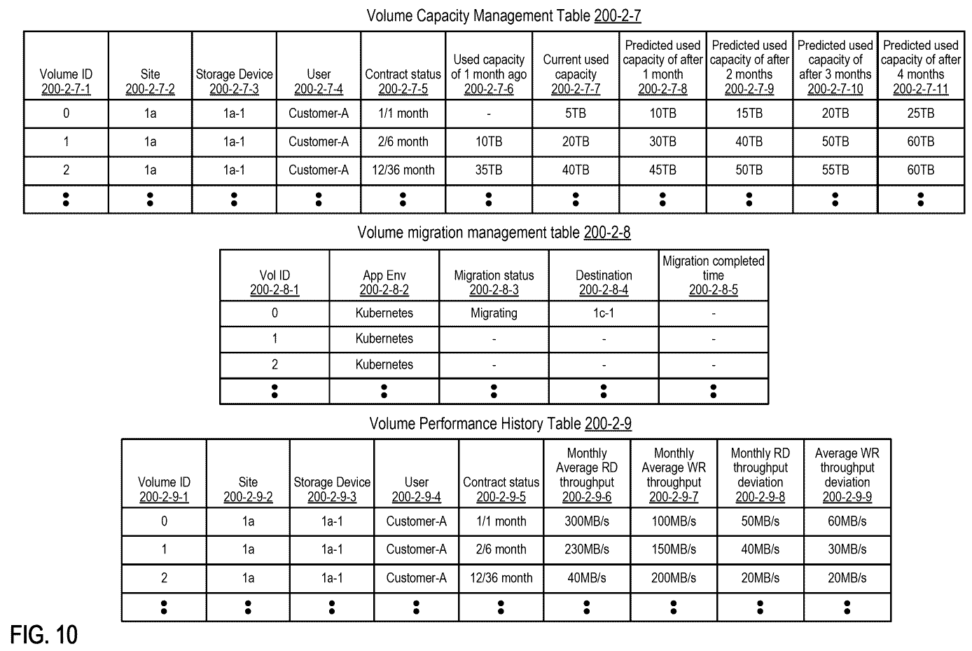

FIG. 10 illustrates example tables for managing information on server 200 for managing volumes, in accordance with an example implementation. Volume capacity management table 200-2-7 stores information of volume contract and its usage, and can include Volume ID 200-2-7-1, site 200-2-7-2, storage device 200-2-7-3, contract status 200-2-7-5, used capacity of one month ago 200-2-7-6, current used capacity 200-2-7-7, predicted used capacity of one month after 200-2-7-8, predicted used capacity of two months after 200-2-7-9, predicted used capacity of three months after 200-2-7-10, predicted used capacity of four months after 200-2-7-11. Volume ID 200-2-7-1 is unique in the system. The number of columns that have the used capacity and/or predicted used capacity can be derived from the maximum of expansion cycle 200-2-2-9. In this example, the six is used because the next expansion cycle needs to be covered.

Volume migration management table 200-2-8 stores information of volume migration status, and can include Volume ID 200-2-8-1, application environment 200-2-8-2, migration status 200-2-8-3, destination 200-2-8-4, and migration completed time 200-2-8-5. Destination 200-2-8-4 has the destination storage device ID.

Volume performance history management table 200-2-9 stores history of performance statistics of each volume and can include Volume ID 200-2-9-1, site 200-2-9-2, storage device 200-2-9-3, user 200-2-9-4, contract status 200-2-9-5, monthly average read throughput 200-2-9-6, monthly average write throughput 200-2-9-7, monthly read throughput deviation 200-2-9-8, and monthly write throughput deviation 200-2-9-9.

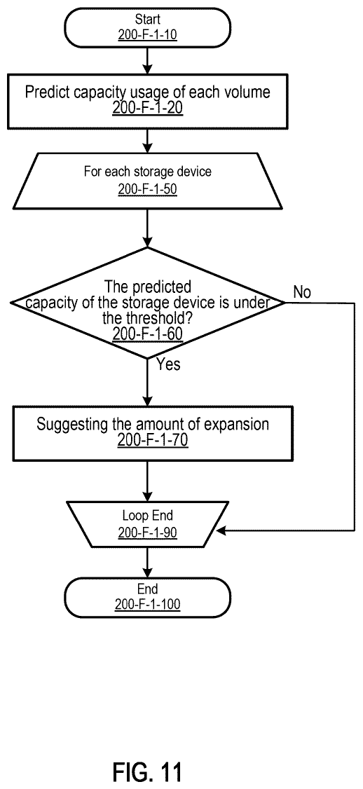

FIG. 11 illustrates an example processing flow in storage management service 200-1 when the expansion process starts or the system capacity is used up in 201-u2, in accordance with an example implementation. At Step 200-F-1-10, this program is invoked automatically upon the time when the expansion process starts. This program is also invoked manually when the system capacity is used up. At Step 200-F-1-20, the flow predicts the capacity usage of each volume by using data from the contract renewal rate management table 200-2-5 and volume capacity management table 200-2-7. In this example implementation, the predicted capacity is calculated by following equations:

$$predicted capacity after n months = current used capacity + ( predicted increasing capacity each month ) * \{ {( 1 + contract renewal rate )}^{⋀} n \}$$

Depending on the desired implementation, the increase in capacity for each month can be calculated by well-known method such as linear regression, and so on.

At Step 200-F-1-50, the flow initiates a loop for each storage device. At Step 200-F-1-60, the flow checks if the predicted capacity of the storage device is under the threshold or not. If so (Yes), the flow proceeds to Step 200-F-1-70, otherwise (No) the flow proceeds to Step 200-F-1-90. At Step 200-F-1-70 the flow provides a suggestion for the amount of expansion. At Step 200-F-1-90, the loop ends and proceeds to the next storage device. Once all of the storage devices are processed, the loop ends at 200-F-1-100.

In example implementations, the amount of expansion is calculated by predicted capacity usage/threshold. For example, if current maximum capacity is 200 TB and predicted capacity usage is 190 TB, then the amount of expansion is 190 TB/0.7=271 TB.

In example implementations described herein, when the suggestion is adopted (e.g., through the user interface as described herein), then additional storage or storage systems can be added based on the flow above. Further, such example implementations can be directed to reducing capacity or deleting storage systems if the predicted capacity usage is to be reduced, or as contracts expire, depending on the desired implementation.

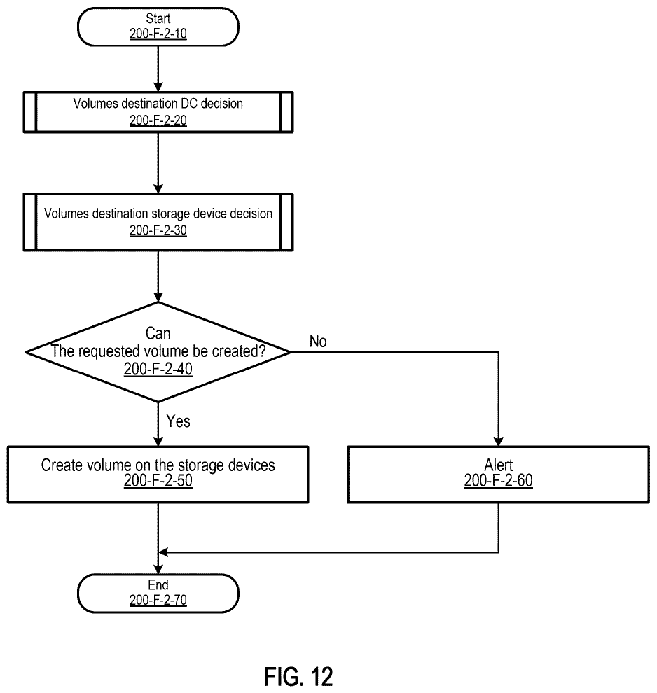

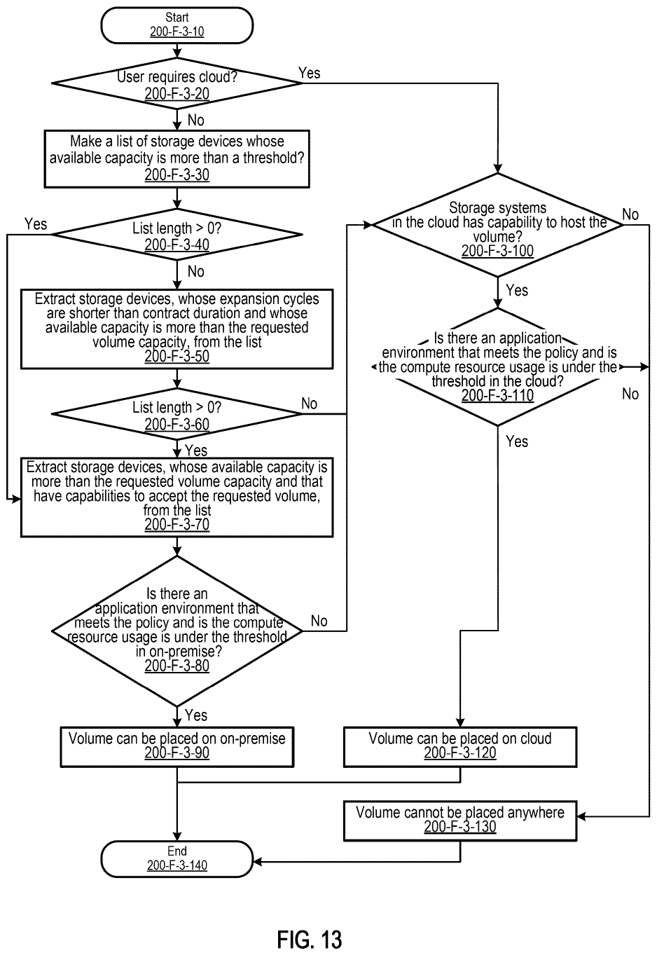

FIG. 12 illustrates an example of the processing flow in storage management service 200-1 when a volume creation request is issued in 201-u4, in accordance with an example implementation. The flow starts at Step 200-F-2-10, and the program is invoked upon volume creation request is issued. At Step 200-F-2-20, the flow decides to which sites the volume is to be created. Further details of this process are described with respect to FIG. 13.

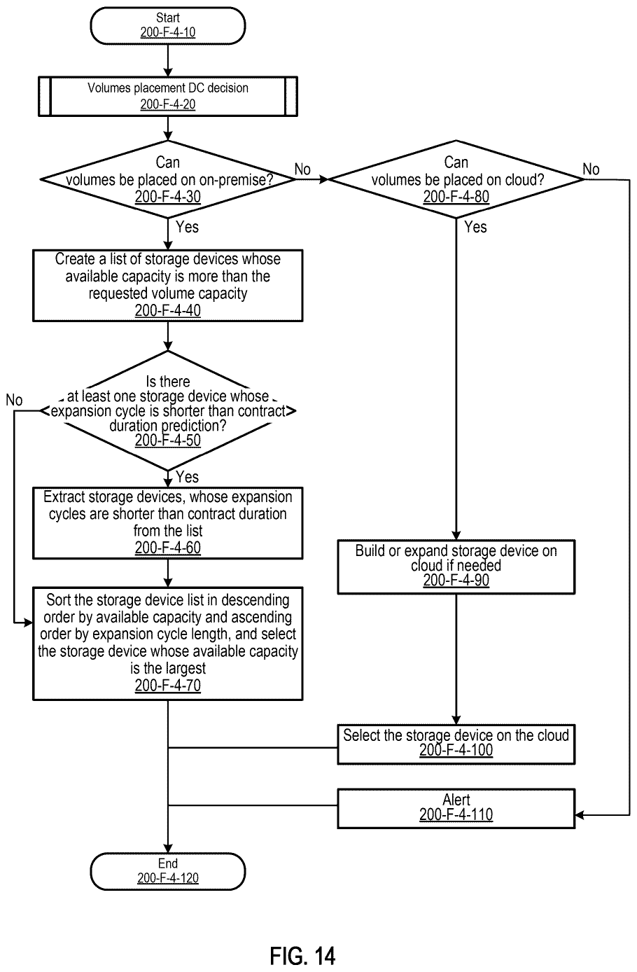

At Step 200-F-2-30, the flow decides which storage devices to which the volume is created. Further details of this process are described with respect to FIG. 14. At Step 200-F-2-40, the flow checks if the requested volume can be created at a storage device or not. If so (Yes), the flow proceeds to Step 200-F-2-50 to create the volume on the storage device. Otherwise (No), the flow proceeds to Step 200-F-2-60 to send an alert to the Provider and Consumer. The flow then ends at Step 200-F-2-70.

FIG. 13 illustrates an example of the processing flow in storage management service 200-1 when a volume creation request is issued in 201-u4, in accordance with an example implementation. The flow begins at Step 200-F-3-10 wherein this program is invoked at Step 200-F-2-20. At Step 200-F-3-20, the flow checks if the user requires the cloud or not. If so (Yes), the flow proceeds to Step 200-F-3-100, otherwise (No), the flow proceeds to Step 200-F-3-30 to make a list of storage devices whose available capacity is more than a threshold. At Step 200-F-3-40, the flow checks if the list length is larger than zero or not. If so (Yes), then the flow proceeds to Step 200-F-3-70, otherwise (No) the flow proceeds to Step 200-F-3-50. At Step 200-F-3-50, the flow extracts the storage devices having expansion cycles that are shorter than contract duration and with available capacity being more than the requested volume capacity, from the list.

At Step 200-F-3-60, the flow checks if the list length is larger than 0 or not. If so (Yes) the flow proceeds to Step 200-F-3-70, otherwise (No) the flow proceeds to Step 200-F-3-100.

At Step 200-F-3-70, the flow extracts the storage devices having an available capacity that is more than the requested volume capacity and that have capabilities to accept the requested volume, from the list. At Step 200-F-3-80, the flow checks if there is an application environment that meets the policy and is the computer resource usage is under the threshold in on-premise or not. If so (Yes), then the flow proceeds to Step 200-F-3-90, otherwise (No) the flow proceeds to Step 200-F-3-100. At Step 200-F-3-90, the flow decides that volume can be placed on on-premise.

At Step 200-F-3-100 the flow checks if the storage devices in the cloud has the capability to host the volume or not. If so (Yes), then the flow proceeds to Step 200-F-3-110, otherwise (No) the flow proceeds to Step 200-F-3-130. At Step 200-F-3-110, the flow checks if there is an application environment that meets the policy and is the computer resource usage is under the threshold in the cloud or not. If so (Yes), then the flow proceeds to Step 200-F-3-120, otherwise (No) the flow proceeds to Step 200-F-3-130.

At Step 200-F-3-120, the flow decides that the volume can be placed on the cloud. At Step 200-F-3-130, the flow decides that the volume cannot be placed anywhere. At Step 200-F-3-140, the flow ends.

FIG. 14 illustrates an example of the processing flow in storage management service 200-1 when a volume creation request is issued in 201-u4, in accordance with an example implementation. This program is invoked at Step 200-F-4-10. At Step 200-F-4-20, the flow decides where to place the volume. At Step 200-F-4-30, the flow checks if the volume can be placed on on-premise or not. If so (Yes), the flow proceeds to Step 200-F-4-40, otherwise (No), the flow proceeds to Step 200-F-4-80. At Step 200-F-4-40, the flow creates a list of the storage devices whose available capacity is more than the requested volume capacity. At Step 200-F-4-50, the checks if there is at least one storage device whose expansion cycle is shorter than contract duration prediction or not. If so (Yes), the flow proceeds to Step 200-F-4-60, otherwise (No) the flow proceeds to Step 200-F-4-70.

At Step 200-F-4-60, the flow extracts storage devices, whose expansion cycles are shorter than contract duration, from the list. At Step 200-F-4-70, the flow sorts the storage device list in descending order by available capacity and ascending order by expansion cycle length, and select the storage device whose available capacity is the largest.

At Step 200-F-4-80, the flow checks if the volume can be placed on the cloud or not. If so (Yes), the flow proceeds to Step 200-F-4-90, otherwise (No), the flow proceeds to Step 200-F-4-110. At Step 200-F-4-90, the flow builds or expands the storage device on the cloud if needed. At Step 200-F-4-100, the flow selects the storage device on the cloud. At Step 200-F-4-110, the flow sends an alert to the provider. At Step 200-F-4-120, the flow ends.

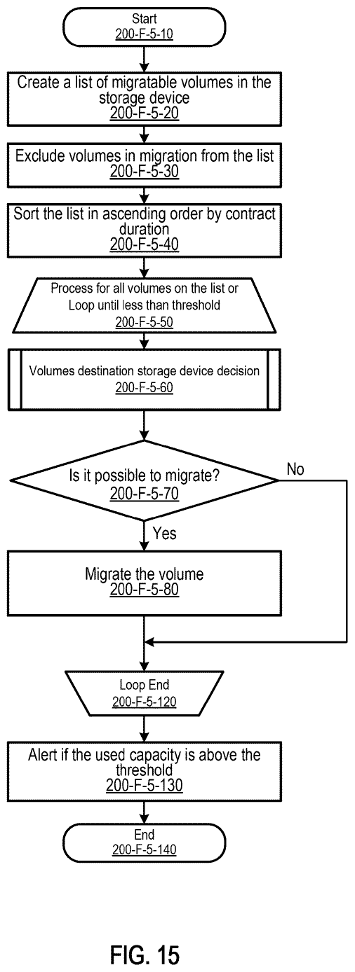

FIG. 15 illustrates the processing flow in storage management service 200-1 when some capacity usage of the storage devices in on-premise data centers exceeds threshold in 201-u3, in accordance with an example implementation.

At Step 200-F-5-10, this program is invoked automatically when capacity usage of the storage device exceeds threshold or periodically, or provider request to start. At Step 200-F-5-20, the flow creates a list of migratable volumes in the storage device. At Step 200-F-5-30, the flow excludes volumes in migration from the list. At Step 200-F-5-40, the flow sorts the list in ascending order by contract duration.

At Step 200-F-5-50, the flow processes for all volumes on the list or Loop until the capacity usage become less than threshold. At Step 200-F-5-60, the flow decides to which storage devices the volume is to be migrated, which is described with respect to FIG. 14.

At Step 200-F-5-70, the flow checks if the destination storage device can accept the volume or not. If so (Yes), the flow proceeds to Step 200-F-5-80 to migrate the volume to the destination. Otherwise (No), the loop ends at Step 200-F-5-120.

At Step 200-F-5-130, an alert is transmitted if the used capacity is above the threshold. At Step 200-F-5-140, the flow ends.

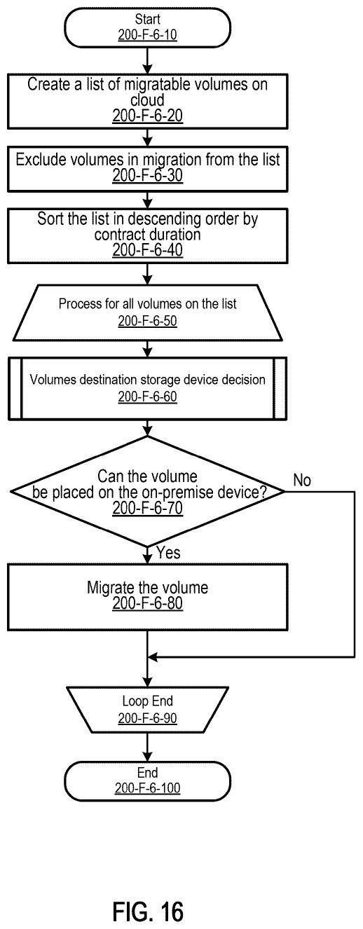

FIG. 16 illustrates the processing flow in storage management service 200-1 when some capacity usage of the storage devices in on-premise data centers is lower than threshold in 201-u3, in accordance with an example implementation. At Step 200-F-6-10, this program is invoked automatically when capacity usage of the storage device become lower than threshold or periodically, or provider request to start. At Step 200-F-6-20, the flow creates a list of migratable volumes in the storage device. At Step 200-F-6-30, the flow excludes volumes in migration from the list. At Step 200-F-6-40, the flow sorts the list in descending order by contract duration. At Step 200-F-6-50, the flow processes for all volumes on the list through use of a loop. At Step 200-F-6-60, the flow decides to which storage devices the volume is to be migrated as described in FIG. 14. At Step 200-F-6-70, the flow checks if the destination storage device can accept the volume or not. If so (Yes), the flow proceeds to Step 200-F-6-80 to migrate the volume to the destination. Otherwise (No), the flow proceeds to the end of the loop at Step 200-F-6-90. The flow then ends at Step 200-F-6-100 after ending the loop at Step 200-F-6-90 after all of the volumes in the list are processed.

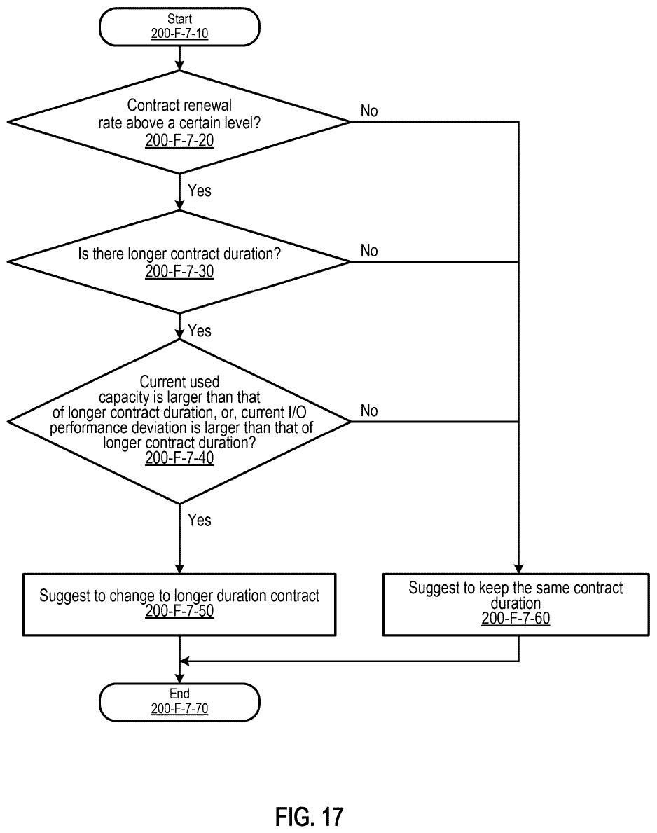

FIG. 17 illustrates the processing flow in storage management service 200-1 when consumers renew their contract of volume service in 201-u5, in accordance with an example implementation.

At Step 200-F-7-10, this program is invoked automatically when at least one volume reaches its contract renewal date or periodically, or provider request to start. At Step 200-F-7-20, the flow checks if there is longer contract duration or not. If so (Yes), the flow proceeds to Step 200-F-7-30, otherwise (No) the flow proceeds to Step 200-F-7-60.

At Step 200-F-7-30, the flow checks if the predicted contract renewal rate is above a certain level or not. If so (Yes), then the flow proceeds to Step 200-F-7-40, otherwise (No), the flow proceeds to Step 200-F-7-60. A certain level is calculated by using the current contract renewal rate and the longer contract renewal rate. For example, in the following situation, a certain level is 50%. The current contract duration is one month and its renewal rate 95%. The longer duration contract is six months and its renewal rate is 50%. The predicted contract renewal rate is calculated by following equation:

$$The predicted contract renewal rate = {( The current contract renewal rate )}^{⋀} ( 2 * longer contract duration / current contract duration - 1 )$$

In this situation, the predicted contract renewal rate is 0.95\hat{ }11>0.6. This is above the threshold 50%.

At Step 200-F-7-40, the flow checks whether either (A) the current used capacity is larger than average capacity usage of longer contract duration, or (B) the current I/O performance deviation is larger than that of longer contract, is true. If so (Yes) the flow proceeds to Step 200-F-7-50 to suggest to change to a longer duration contract for the volume. Otherwise (No) the flow proceeds to Step 200-F-7-60 to suggest to keep current contract of the volume. The flow ends at Step 200-F-7-70.

Through example implementations described herein, several benefits can be incurred on the service provider (infra engineers) side, such as the equipment expansion can be reduced to once every few months, and the equipment expansion can follow fluctuation automatically. Through example implementations for the effects on the service user (application engineers) side, longer contract terms reduce infrastructure usage costs.

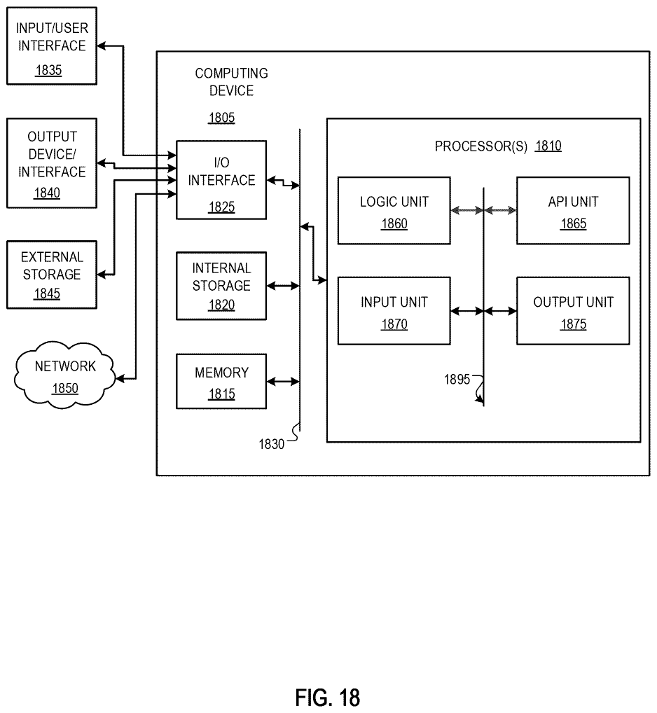

FIG. 18 illustrates an example computing environment with an example computer device suitable for use in some example implementations according to various embodiments of the present disclosure. Computer device 1805 in computing environment 1800 can include one or more processing units, cores, or processors 1810, memory 1815 (e.g., RAM, ROM, and/or the like), internal storage 1820 (e.g., magnetic, optical, solid-state storage, and/or organic), and/or I/O interface 1825, any of which can be coupled on a communication mechanism or bus 1830 for communicating information or embedded in the computer device 1805. I/O interface 1825 is also configured to receive images from cameras or provide images to projectors or displays, depending on the desired implementation.

Computer device 1805 can be communicatively coupled to input/user interface 1835 and output device/interface 1840. Either one or both of input/user interface 1835 and output device/interface 1840 can be a wired or wireless interface and can be detachable. Input/user interface 1835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1840 may include a display, television, monitor, printer, speaker, braille, or the like. In some example implementations, input/user interface 1835 and output device/interface 1840 can be embedded with or physically coupled to the computer device 1805. In other example implementations, other computer devices may function as or provide the functions of input/user interface 1835 and output device/interface 1840 for a computer device 1805.

Examples of computer device 1805 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1805 can be communicatively coupled (e.g., via I/O interface 1825) to external storage 1845 and network 1850 for communicating with any number of networked components, devices, and systems, including one or more computer devices of the same or different configurations. Computer device 1805 or any connected computer device can be functioning as, providing services of, or referred to as a server, client, thin server, general machine, special-purpose machine, or another label.

I/O interface 1825 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1800. Network 1850 can be any network or combination of networks (e.g., the Internet, local area network, wide area network, a telephonic network, a cellular network, a satellite network, and the like).

Computer device 1805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1810 can execute under any operating system (OS) (not shown), in a native or virtual environment. One or more applications can be deployed that include logic unit 1860, application programming interface (API) unit 1865, input unit 1870, output unit 1875, and inter-unit communication mechanism 1895 for the different units to communicate with each other, with the OS, and with other applications (not shown). The described units and elements can be varied in design, function, configuration, or implementation and are not limited to the descriptions provided. Processor(s) 1810 can be in the form of hardware processors such as central processing units (CPUs) or a combination of hardware and software units.

In some example implementations, when information or an execution instruction is received by API unit 1865, it may be communicated to one or more other units (e.g., logic unit 1860, input unit 1870, output unit 1875). In some instances, logic unit 1860 may be configured to control the information flow among the units and direct the services provided by API unit 1865, input unit 1870, and output unit 1875, in some example implementations described above. For example, the flow of one or more processes or implementations may be controlled by logic unit 1860 alone or in conjunction with API unit 1865. The input unit 1870 may be configured to obtain input for the calculations described in the example implementations, and the output unit 1875 may be configured to provide output based on the calculations described in example implementations.

Processor(s) 1810 can be configured to execute a method or instructions for a storage management system (e.g., as facilitated by server 200) configured to manage storage systems, which can include, for a start of a lead time defined for an expansion cycle being reached, generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and for the suggestion being accepted, adding the capacity amount to the storage systems, as illustrated, for example, in FIGS. 7 and 11.

Processor(s) 1810 can be configured to execute the method or instructions as described above, and further involve creating additional new storage systems or deleting ones of the storage systems based on the capacity availability corresponding to on-premises storage devices, the contract term for the one or more volumes in the storage systems, and the contract renewal rate for the one or more volumes in the storage systems as illustrated in FIG. 11.

Processor(s) 1810 can be configured to execute the method or instructions as described above, and further involve migrating ones of the one or more volumes to cloud according to the capacity availability corresponding to on-premises storage devices, the contract term for the one or more volumes in the storage systems, and the contract renewal rate for the one or more volumes in the storage systems as illustrated in FIGS. 13-16.

Processor(s) 1810 can be configured to execute the method or instructions as described above, and further involve providing a proposed contract extension based on the contract renewal rate for the one or more volumes, used capacity in the storage systems, and I/O performance deviation as illustrated in FIG. 17.

Processor(s) 1810 can be configured to execute the method or instructions for a storage management system configured to manage storage systems, which can include, for receipt of a request to generate a new volume, determining a location in the storage systems to place the new volume based on an expansion cycle for each device, expansion lead time, capacity availability, contract term for each application, and contract renewal rate; and generating the new volume in the determined location as illustrated in FIGS. 13-16.

Processor(s) 1810 can be configured to execute the method or instructions as described above, and further involve creating additional new storage systems or deleting ones of the storage systems based on the capacity availability corresponding to on-premises storage devices, the contract term for one or more volumes in the storage systems, and the contract renewal rate for the one or more volumes in the storage systems as illustrated in FIG. 11.

Processor(s) 1810 can be configured to execute the method or instructions as described above, and further involve migrating one or more volumes to cloud according to the capacity availability corresponding to on-premises storage devices, the contract term for the one or more volumes in the storage systems, and the contract renewal rate for the one or more volumes in the storage systems as illustrated in FIGS. 13-16.

Processor(s) 1810 can be configured to execute the method or instructions as described above, and further involve providing a proposed contract extension based on the contract renewal rate for the one or more volumes, used capacity in the storage systems, and I/O performance deviation as illustrated in FIG. 17.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for a storage management system configured to manage storage systems, the method comprising:
for a start of a lead time defined for an expansion cycle being reached:
generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and
for the suggestion being accepted, adding the capacity amount to the storage systems.

2. The method of claim 1, further comprising creating additional new storage systems or deleting ones of the storage systems based on the capacity availability corresponding to on-premises storage devices, the contract term for the one or more volumes in the storage systems, and the contract renewal rate for the one or more volumes in the storage systems.

3. The method of claim 1, further comprising migrating ones of the one or more volumes to cloud according to the capacity availability corresponding to on-premises storage devices, the contract term for the one or more volumes in the storage systems, and the contract renewal rate for the one or more volumes in the storage systems.

4. The method of claim 1, further comprising providing a proposed contract extension based on the contract renewal rate for the one or more volumes, used capacity in the storage systems, and I/O performance deviation.

5. A method for a storage management system configured to manage storage systems, the method comprising:
for receipt of a request to generate a new volume:
determining a location in the storage systems to place the new volume based on an expansion cycle for each device, expansion lead time, capacity availability, contract term for each application, and contract renewal rate; and
generating the new volume in the determined location.

6. The method of claim 5, further comprising creating additional new storage systems or deleting ones of the storage systems based on the capacity availability corresponding to on-premises storage devices, the contract term for one or more volumes in the storage systems, and the contract renewal rate for the one or more volumes in the storage systems.

7. The method of claim 5, further comprising migrating one or more volumes to cloud according to the capacity availability corresponding to on-premises storage devices, the contract term for the one or more volumes in the storage systems, and the contract renewal rate for the one or more volumes in the storage systems.

8. The method of claim 5, further comprising providing a proposed contract extension based on the contract renewal rate for one or more volumes, used capacity in the storage systems, and I/O performance deviation.

9. A non-transitory computer readable medium, storing instructions for a storage management system configured to manage storage systems, the instructions comprising:
for a start of a lead time defined for an expansion cycle being reached:
generating a suggestion comprising a capacity amount for the expansion cycle based on an expansion cycle for each equipment in the storage systems, expansion lead time, capacity availability, contract term for one or more volumes in the storage systems, and contract renewal rate for the one or more volumes in the storage systems; and
for the suggestion being accepted, adding the capacity amount to the storage systems.

10. The non-transitory computer readable medium of claim 9, the instructions further comprising creating additional new storage systems or deleting ones of the storage systems based on the capacity availability corresponding to on-premises storage devices, the contract term for the one or more volumes in the storage systems, and the contract renewal rate for the one or more volumes in the storage systems.

11. The non-transitory computer readable medium of claim 9, the instructions further comprising migrating ones of the one or more volumes to cloud according to the capacity availability corresponding to on-premises storage devices, the contract term for the one or more volumes in the storage systems, and the contract renewal rate for the one or more volumes in the storage systems.

12. The non-transitory computer readable medium of claim 9, the instructions further comprising providing a proposed contract extension based on the contract renewal rate for the one or more volumes, used capacity in the storage systems, and I/O performance deviation.
